(19) United States
(12) Patent Application Publication
(10) Pub. No.: US 2012/0221356 A1
(43) Pub. Date: Aug. 30, 2012

(54) PROCESS APPARATUS AND MUTUAL INSURANCE METHOD FOR USE IN THE PROCESS APPARATUS

(75) Inventor: Hsiao-Ling HSU, Taipei City (TW)

(73) Assignee: SHACOM.COM INC., Taipei (TW)

(21) Appl. No.: 13/033,690

(22) Filed: Feb. 24, 2011

(51) Int. Cl. G06Q 40/00

(52) U.S. Cl. 705/4

(57) ABSTRACT

A process apparatus and a mutual insurance method for use in the process apparatus are provided. The process apparatus stores the mutual data of a mutual insurance assembly. The mutual data comprises the time weight of a specific period, an insured unit and the standard amount benefit of each mutual member. The process apparatus retrieves a valid insured unit in the specific period from the insured units according to the accident message of an accident member. Then, the process apparatus calculates a benefit, which the accident member may obtain, according to the time weight, the valid insured unit and the standard amount benefit. Whereby, the process and security of the insurance are simplified and improved respectively.

### FIELD

The present invention relates to a process apparatus and a mutual insurance method performed by the process apparatus. In particular, the present invention provides a process apparatus capable of calculating a benefit according to an insurance unit chosen by each of a plurality of mutual members and a mutual insurance method performed by the process apparatus.

### BACKGROUND

Insurance has been used by people to protect their own benefits and welfare. By choosing an insurance product and paying a premium of a fixed amount on a regular basis, policyholders or their family members can be supported by insurance claim payments in case of an accident. The insurance claim payments can further reduce damages caused by the accident to the living and economic conditions of the policyholders or their family members, thereby achieving the purpose of self-protection.

The conventional insurance system adopts a system of mutual insurance so that all members who join the insurance can lend their aid to each other when a crisis or an accident occurs. However, in the conventional insurance system, insurance companies determine the risk of members in the insurance system according to objective conditions and statistical probabilities. For example, in health insurance and life insurance products, insurance companies usually rate the premiums or increase the premiums according to age and medical histories of applicants. The insurances charge a higher premium for those presenting high risks and a lower premium for those presenting low risks.

However, with conventional mutual insurance, members who conceal their health or employers who fail to collect all the information of their employees often cause the insurance companies to pay a larger accident amount. Due to the nature of the mutual insurance system, other members have to pay an unfair amount of premium. Moreover, the mutual insurance system further has a problem of insufficient flexibility, which makes it impossible to offer an appropriate benefit according to the conditions and demands of each of the members joining the insurance. In other words, the mechanism in which insurance companies currently determine the premiums with full authority may result in an inequality, in which members who pay a lower premium receive more benefits while members who pay a higher premium receive fewer benefits during an accident; thus, losing the original intention of mutual insurance.

Furthermore, the existing insurance operation process (e.g., the insurance application, insurance verification, premium collection, settlement of claims and etc.) involves many employees. Such an operational mode not only increases the operational cost of insurance companies, but also tends to cause various drawbacks. For example, the insurance information might be deliberately concealed by insurance employees, the insurance premium may be cheated by the insurance employees, or the benefits may be embezzled by malicious persons. This adds many risks to the insurance which had been originally established with good intention.

Due to the development of network technologies, conventional insurance schemes have already performed the front-end operations of insurance operation processes (e.g., the insurance application) via a network to reduce the involvement of people in the insurance operation process. All these technologies are new transaction modes that have been developed with increased consumer sovereignty and transaction information symmetry. Unfortunately, technical difficulties in integration with network technologies still exist for the back-end operations of the insurance operation process, i.e., the insurance verification, premium collection and settlement of claims.

Accordingly, a need remains in the art to provide an insurance platform that allows the public to choose premiums themselves with fairness and flexibility. The insurance platform shall have the network and insurance operations integrated together, and allow members joining in the insurance platform to choose the premiums, according to their own conditions, that they would pay themselves to improve the flexibility of the system and maintain the nature of fairness of the insurance platform. Thereby, risks for both the members and the insurance companies generated in the mutual insurance can be decreased and the insurance operation process can be simplified to further satisfy the insurance demands of both sides.

### SUMMARY

An objective of certain embodiments of the present invention is to provide a process apparatus and a mutual insurance method for use in the process apparatus. The mutual insurance method is performed by the process apparatus to provide a mutual insurance system with both fairness and efficiency. By allowing a policyholder to choose a premium rate according to his or her own risks and by deciding how much benefit the policyholder can receive during an accident according to the premium he has paid, the risk of speculative insurance and the expenditure on credit investigation are reduced, and risks of the policyholder can be reflected faithfully by the premium. This also improves the premium flexibility of the mutual insurance, thereby promoting the participation of the public in the insurance system.

To achieve the aforesaid objective, the process apparatus in certain embodiments comprises a storage, an input/output (I/O) interface and a microprocessor. The microprocessor is electrically connected to the storage and the I/O interface respectively. The storage is configured to store mutual information of a mutual insurance assembly. The mutual insurance assembly has a plurality of mutual members, which comprises an accident member. The mutual information comprises the time weight of a specific period, an insurance unit of each of the plurality of members and a standard payment amount. The I/O interface is configured to receive an accident message of the accident member. The microprocessor is configured to retrieve a valid insurance unit of the accident member in the specific period, according to the accident message from the insurance units of the storage, and to calculate the benefit of the accident member according to the time weight, the valid insurance unit and the standard payment amount.

Furthermore, to achieve the aforesaid objective in certain embodiments, the mutual insurance method for use in the process apparatus comprises the following steps: enabling the I/O interface to receive an accident message of the accident member; enabling the microprocessor to retrieve a valid insurance unit of the accident member in the specific period, according to the accident message from the insurance units of the storage; and enabling the microprocessor to calculate the benefit of the accident member according to the time weight, the valid insurance unit and the standard payment amount.

According to the above descriptions, the present invention allows policyholders to adjust their own premiums flexibly according to their own conditions so that the premium amounts can faithfully reflect their own values-at-risk. Thus, risks can be positively controlled to reduce speculative insurance events significantly. Meanwhile, the probability of inappropriate risk assessment can be decreased to reduce the cost of risk assessment. Moreover, allowing users to determine premiums themselves is compatible with the current operation mode of the Internet, which can not only significantly improve transparency and operation efficiency of the mutual insurance assembly and reduce operational and administrational costs, but also significantly improve the mutual equity and impartiality of the premium payment in the mutual insurance assembly, thereby effectively overcoming shortcomings of the prior art.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a schematic view of a process apparatus according to a first example embodiment of the present invention; and

FIGS. 2A-2E illustrate flowcharts according to a second example embodiment of the present invention.

### DETAILED DESCRIPTION

In the following descriptions, the present invention will be explained with reference to example embodiments thereof. However, these example embodiments are not intended to limit the present invention to any specific example, environment, embodiment, applications or particular implementations described in these example embodiments. Therefore, descriptions of these example embodiments are only for purposes of illustration rather than limitation to the invention. It should be appreciated that in the following example embodiments and the attached drawings, elements unrelated to the present invention are omitted from depiction; and dimensional relationships among individual elements in the attached drawings are illustrated only for ease of understanding, but not to limit the actual scale.

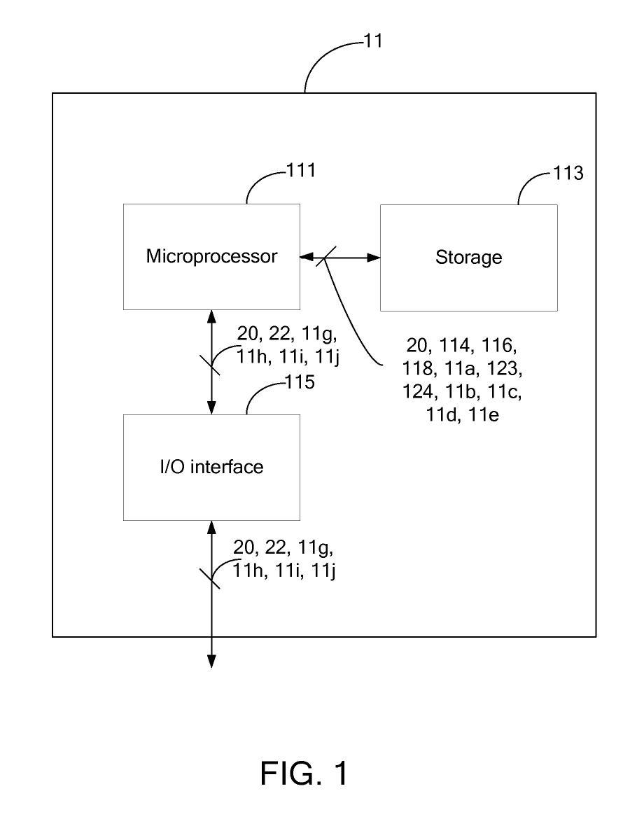

A schematic view of a process apparatus 11 according to a first example embodiment of the present invention is shown in FIG. 1. The process apparatus 11 comprises a microprocessor 111, a storage 113 and an input/output (I/O) interface 115. The microprocessor 111 is electrically connected to the storage 113 and the I/O interface 115 respectively. The storage 113 is configured to store mutual information 123 of a mutual insurance assembly which has a plurality of mutual members. The mutual information 123 comprises a time weight 116 of a specific period, an insurance unit 114 of each of the plurality of mutual members, a standard payment amount 118, an insurance unit range 11a, exclusive period information 11b, a profit term 11c, and paid premium information 11d of each of the plurality of mutual members. Functions of the information elements comprised in the mutual information 123 will be described hereinafter.

Furthermore, in this embodiment, the process apparatus 11 may be a server disposed in a network. The microprocessor 111 may be a central processing unit (CPU) of the server, the storage 113 may be a hard disk of the server, and the I/O interface 115 may be an I/O interface conforming to standards of the network. In other embodiments, the process apparatus 11 may be one of other apparatuses with functions similar to the server instead of being limited to what is illustrated above.

The mutual insurance assembly comprises a plurality of insurance periods, and each mutual member joining in the mutual insurance assembly needs to choose a current insurance unit according to his own conditions in each insurance period. In other words, the insurance unit of each mutual member may vary with different insurance periods. Therefore, the I/O interface 115 of the process apparatus 11 receives a current insurance unit 20 of each mutual member in each insurance period, and the insurance unit 114 of each of the plurality of mutual members described above is just configured to record the insurance units (e.g., a last insurance unit and a current insurance unit) of the mutual member in each insurance period.

The insurance unit range 11a stored in the storage 113 of the process apparatus 11 is configured to avoid the case where a mutual member who anticipates an immediate accident will choose a large mutual insurance unit in the next insurance period to result in speculation and unfairness. Specifically, after the I/O interface 115 of the process apparatus 11 receives the current insurance unit 20, the microprocessor 111 of the process apparatus 11 determines whether the current insurance unit 20 is in the insurance unit range 11a according to a last insurance unit 11e of each mutual member in a last insurance period.

If the microprocessor 111 determines that the current insurance unit 20 is not in the insurance unit range 11a, then the current insurance unit 20 of the mutual member is rejected in this insurance period. Otherwise, if the microprocessor 111 determines that the current insurance unit 20 is in the insurance unit range 11a, then the current insurance unit 20 of the mutual member is accepted in this insurance period, and the current insurance unit 20 is updated and recorded to the insurance unit 114 of the mutual member.

For example, assume that according to the insurance unit range 11a, an insurance unit in each insurance period should not exceed that of the last insurance period by a fixed value (e.g., 3 units) or a proportion (e.g., thirty percent), and that the last insurance unit is 5 units. Then, the current insurance unit should not be more than 8 units according to the fixed value or not more than 6.5 units according to the proportion. Thus, the insurance unit range can be defined clearly so that the premiums of each mutual member increase in a gradual way to prevent abnormal insurance unit increments made by a speculator. Depending on practical applications, the aforesaid insurance unit range 11a may be a different range in other embodiments, and this is not intended to limit the scope of the present invention.

In case a mutual member meets an accident, the process apparatus 11 will operate to handle related settlement of claims/compensation. For ease of the following descriptions, the mutual member who meets an accident will be called for short as an accident member hereinafter. In other words, the aforesaid plurality of mutual members comprises the accident member.

After the I/O interface 115 of the process apparatus 11 receives an accident message 22 of the accident member, the microprocessor 111 of the process apparatus 11 determines whether the accident member meets the accident outside an exclusive period according to the accident message 22 and the exclusive period information 11b to perform subsequent processing correspondingly. Specifically, the accident message 22 may comprise information of the accident member such as an ID number, an age, the time of joining in the mutual insurance assembly and the time of the accident. The exclusive period is a mechanism configured to prevent moral risks: if a mutual member could receive a total insurance benefit after joining the mutual insurance assembly for only several months, it would be unfair for other mutual members.

In this embodiment, the exclusive period is two years. The microprocessor 111 is configured to determine whether the difference between the time of the accident member joining the mutual insurance assembly and the time of the accident is more than two years. If the answer is “yes”, then it is determined that the accident member meets the accident outside the exclusive period; otherwise, if the answer is “no”, then it is determined that the accident member meets the accident in the exclusive period.

If the accident member meets the accident outside the exclusive period, the microprocessor 111 of the process apparatus 11 retrieves the valid insurance unit 124 of the accident member in the specific period from the insurance unit of the storage 113 according to the accident message 22. After retrieving the valid insurance unit 124, the microprocessor 111 calculates the benefit 11g of the accident member according to the time weight 116, the valid insurance unit 124 and the standard payment amount 118, and removes the accident member from the mutual insurance assembly.

Specifically, if each insurance period is a quarter and the specific period is the last two years before the accident, then the insurance units of the accident member in each of the last eight insurance periods before the accident are recorded in the valid insurance unit 124. The microprocessor 111 takes the weighted average of the chosen mutual units (i.e., the insurance units in the last eight insurance periods) according to the time weights 116 (i.e., the time weights of the last two years before the accident), and makes an operation on the standard payment amount 118 according to the resulting weighted average to calculate the benefit for the current accident of the accident member.

The purpose of making the aforesaid operation according to the time weights 116, the valid insurance unit 124 and the standard payment amount 118 is that the more mutual units the accident member has chosen (i.e., the more mutual premiums the accident member has paid) in the last several insurance periods, the more benefits the mutual member can receive after an accident. Thus, when choosing a mutual unit amount, the mutual member will assess his own health conditions so that the mutual premiums can reflect the health condition of the mutual member faithfully. By collecting the different premiums according to true risk statuses of the policyholders, insurance inequalities that result from insurances of the prior art can be prevented.

More specifically, in this embodiment, the benefit of the accident member is determined by the following formula:

$$Pi = Ps \times {\sum }_{j}^{ } {G}_{j} {W}_{j}$$

where, Pi represents the benefit 11g of the accident member, Ps represents the standard payment amount 118, Gⱼ represents the mutual unit paid in the j^{th} insurance period before an accident, and Wⱼ represents the time weight of the j^{th} insurance period before an accident. It should be noted that in other embodiments, the benefit of the accident member may also be determined by other formulas, and this is not intended to limit the scope of the present invention.

If the accident member meets an accident in the exclusive period, the microprocessor 111 of the process apparatus 11 will calculate the compensation 11h of the accident member according to the paid premium information 11d of the accident member. Specifically, in this embodiment, the amount of the compensation 11h is equal to an accumulated total of premiums paid by the accident member after joining the mutual insurance assembly plus interests. It should be noted that in other embodiments, the compensation 11h may also be calculated in other ways, and this is not intended to limit the scope of the present invention.

The above description describes the method where the process apparatus 11 calculates the benefit 11g or the compensation 11h for an accident member when the mutual member has an accident. However, for the mutual insurance assembly, accident members only account for a very small percentage of all mutual members, so the following description will focus on what roles the mutual members that haven't had an accident (referred to as “non-accident members” hereinafter) will play in the mutual insurance assembly and what information the process apparatus 11 will generate for non-accident members in each insurance period.

After calculating the benefit and/or the compensation of accident members, the microprocessor 111 of the process apparatus 11 will determine whether each non-accident member meets the profit term 11c to perform subsequent processing correspondingly. In this embodiment, the profit term 11c may be when the premiums paid by the non-accident member reach a predetermined value and that the time of the non-accident member joining in the mutual insurance assembly reaches a predetermined time. For example, the profit term 11c may be set so that the time of the non-accident member joining the mutual insurance assembly has reached a preset time (e.g., 240 insurance periods in 20 years (one insurance period per month)) and/or that the accumulated premium paid by the non-accident member in previous insurance periods has reached a predetermined amount (e.g., the standard payment amount 118).

In other words, the microprocessor 111 of the process apparatus 11 determines whether the premium paid by each non-accident member has reached the predetermined amount or whether the time of each non-accident member joining the mutual insurance assembly has reached the predetermined time. It should be noted that in other embodiments, the profit term 11c may be adjusted depending on the practical applications, and this is not intended to limit the scope of the present invention. For ease of the following description, non-accident members that do not meet the profit term 11c will be referred to as first non-accident members, while non-accident members that meet with the profit term 11c will be referred to as second non-accident members.

Hereinbelow, subsequent operations to be performed by the process apparatus 11 when it is determined that the non-accident member is a second non-accident member will be described first. After determining that the second non-accident member meets with the profit term 11c, the microprocessor 111 of the process apparatus 11 will further calculate a non-accident profit 11i of the second non-accident member according to the profit term 11c. Specifically, the non-accident profit 11i may be viewed as a survivorship mutual fund or a survivorship annuity, which aims to reward those who have an accident later or to support the daily life of those who live longer. The non-accident profit 11i may be paid in a lump sum, in installments, or on a regular basis at a fixed amount, for example, in the form of an annuity or monthly petty cash.

Generally speaking, the non-accident profit 11i is related to the number of accident members of previous insurance periods in the mutual insurance assembly; i.e., the more accident members, the more the non-accident profit premiums are contributed by the accident members to the non-accident members. This is intended to overcome the shortcoming of the prior art that those who have an accident later in the mutual insurance assembly have to pay more premiums, so that insurance benefits can be allocated in a fairer way to the accident members who have accidents in different periods. Therefore, those who have an accident earlier cannot receive the non-accident profit, but the mutual members who have not had an accident yet and continuously pay premiums can obtain the non-accident profit 11i as a reward for their longevity and for their continuous payment of mutual premiums.

Next, subsequent operations that are performed by the process apparatus 11 when it is determined that the non-accident member is a first non-accident member will be described. The microprocessor 111 of the process apparatus 11 calculates a current payment amount according to at least the non-accident profits of all the first non-accident members and the benefits and/or compensations of the accident members in each insurance period, and further divides the current payment amount by a current insurance unit amount of the mutual members to calculate a current insurance unit value in each insurance period. Finally, the microprocessor 111 multiplies the current insurance unit value by the current insurance unit of the first non-accident member to calculate a current mutual premium 11j that the first non-accident member should pay. The microprocessor 111 of the process apparatus 11 can notify, through an electronic communication device or an intermediary service node, the mutual member to pay the premium. Here, the electronic communication device may be a wireless communication device with SMS/MMS or e-mail functionalities such as a cell phone, a PDA or a computer. The payment may be made by remitting the current mutual premium to a specific account through an electronic trading system (e.g., through a cell phone, a PDA, or through credit card online payment), a convenience store, a bank, a bill and the like. After the mutual member has paid the current mutual premium, a payment acknowledgement message will be received by the system from the specific account.

Specifically, to ensure sustainability of the mutual insurance assembly, the microprocessor 111 of the process apparatus 11 averagely apportions the current payment of the mutual insurance assembly including the non-accident profits of all the first non-accident members and the benefits and/or compensations of the accident members to the current insurance units in each insurance period so that each insurance unit bears the same payment amount. Accordingly, mutual members with more current insurance units will bear a higher premium, while mutual members with fewer current insurance units will bear a lower premium. This mechanism is intended to allow a mutual member to determine his mutual units according to his current financial ability. For example, if the mutual member does not have enough funds in the current period, he may choose fewer mutual units to maintain his mutual membership and continue to enjoy the insurance by paying a lower premium. This flexibility in payment also helps to meet with demands of most applicants under the principle of equity to promote their participation in the mutual insurance.

While choosing fewer mutual units and paying a lower mutual premium, the mutual member may be aware that in subsequent insurance periods, he shall be more cautious, pay more attention to his own health and diet, or pay more attention to the maintenance of workshop and safety facilities to decrease the probability of having an accident. This leads to another positive effect of the improved mutual insurance method of the present invention; that is, it not only provides the members insurance benefits when having an accident, but also substantially reduces the probability of having an accident.

The current insurance unit value and the current mutual premium can be determined by the following two formulas:

V=Pₐₗₗ/Gₙₐₗₗ

I=Gₙ*V

where, V represents the current insurance unit value, Pₐₗₗ all represents the current payment amount, Gₙₐₗₗ represents the current insurance unit amount, I represents the current mutual premium, and Gₙ represents the current insurance unit of a first non-accident member.

To further highlight the technical features of the present invention, several examples will be illustrated hereinafter. In an example, Xiao Ming has applied to join in a mutual insurance assembly in which the number N of members is 1,001, each month is taken as an insurance period, and the standard payment amount is $500,000. Then, a member A in the mutual insurance assembly died on the 12^{th} of that month. After receiving the accident message that member A has died, the process apparatus 11 determines that the death time of member A is outside an exclusive period (i.e., two years) set by the mutual insurance assembly. Then, the benefit that shall be paid to member A is determined according to time weights of every half year in the last two years before the accident. For example, the time weights are set as follows:

| | Before accident | | | |
|---|---|---|---|---|
| | 0-6 months | 7-12 months | 13-18 months | 19-24 months |
| Weight | 0.1 | 0.3 | 0.4 | 0.2 |

Assume that mutual units chosen by A for each month in the last two years before the accident are as follows:

| | Before accident | | | |
|---|---|---|---|---|
| | 0-6 months | 7-12 months | 13-18 months | 19-24 months |
| Mutual | 10 | 8 | 8 | 7 |
| units | | | | |

Accordingly, when member A meets the accident, the insurance benefit of member A is equal to the ratio of the mutual units weighted by the time weights to the standard payment amount, which is calculated as:

{(10/10*0.1)+(8/10*0.3)+(8/10*0.4)+(7/10*0.2)}*$500,000=$400,000.

Therefore, the process apparatus 11 will appropriate the benefit of $400,000 to a nominated bank account of a beneficiary of member A. On the 15^{th} of the same month, the process apparatus 11 further receives an accident message of member B in the mutual insurance assembly. The process apparatus 11 determines that member B meets the accident in the exclusive period because only twelve months have elapsed since the date of application of member B. Furthermore, the paid premium information of member B indicates that the premiums previously paid by the member B totaled $25,000. Therefore, the process apparatus 11 appropriates a compensation (i.e., the paid premium amount) of $25,000 to a nominated bank account of a beneficiary of member B. However, to calculate the premium that other non-accident mutual members should pay, the system still calculates the original benefit of member B as {(8/10*0.1)+(8/10*0.3)}*(24/12)*500,000=$320,000 according to the mutual units (supposed to be 8 in each month) chosen by member B in the last 12 months.

Hence, up to the clearing day of that month, two insured persons in total have died in this month, and the microprocessor 111 of the process apparatus 11 calculates the total current payment amount to be $720,000. Assuming that the mutual unit amount chosen by all non-accident members who should pay the premium is 6000 mutual units, then the microprocessor 111 calculates the current insurance unit value to be $720,000/6000=$120, i.e., $120 per insurance unit. Then, if Xiao Ming has chosen 5 mutual units in the current insurance period, he should pay a current mutual premium of $120×5=$600. To balance $295,000 between the original benefit $320,000 of member B and the compensation $25,000 actually paid to member B, the amount is entrusted to a balance fund account by the process apparatus 11 to balance the payment interruption of some insured persons or loss incurred by other unexpected events in the mutual insurance assembly.

In another example, Xiao Hua, on behalf of his father, has applied to join a mutual insurance assembly which promises a mutual profit. In this mutual insurance assembly, the number N of members is 1,001, each month is taken as an insurance period, and the standard payment amount is $500,000.

Thereafter, member C in the mutual insurance assembly had an accident on 8^{h} of that month. After receiving the accident message that member C has had an accident, the process apparatus 11 determines that the accident time of member C is outside an exclusive period (i.e., two years) of the mutual insurance assembly. In other words, member C has joined the mutual insurance assembly for at least two years. Then, the benefit is determined according to the time weights of every half year in the last two years before the accident. The time weights are set as follows:

| | Before accident | | | |
|---|---|---|---|---|
| | 0-6 months | 7-12 months | 13-18 months | 19-24 months |
| Weight | 0.1 | 0.2 | 0.4 | 0.3 |

Assume that mutual units chosen by member C in each month in the last two years before accident are as follows:

| | Before accident | | | |
|---|---|---|---|---|
| | 0-6 months | 7-12 months | 13-18 months | 19-24 months |
| Mutual | 8 | 8 | 8 | 6 |
| units | | | | |

Accordingly, when member C meets the accident, the benefit of member C is equal to the ratio of the mutual units weighted by the time weights to the standard payment amount, which is calculated as: {(8/10*0.1)+(8/10*0.2)+(8/10*0.4)+(6/10*0.3)}*$500,000=$370,000. Therefore, the system appropriates the benefit of $370,000 to a nominated bank account of member C or a beneficiary of member C.

Meanwhile, when closing an account in the last insurance period, the process apparatus 11 found that two mutual members D and E have met with a profit term which, in this example, is that an accumulated premium amount paid by a mutual member in previous insurance periods has reached the standard payment amount, i.e., $500,000. Then, from the current insurance period, members D and E no longer need to pay any premium, and meanwhile, can receive a non-accident profit monthly or in a lump sum. The amount of the non-accident profit received in a lump sum can be estimated by the process apparatus 11 according to the actual death rate of the mutual insurance assembly in the past. In this example, assume that the system actuarially evaluates that the non-accident profit may be received in a lump sum in an amount of $150,000, or received in installments (e.g., $3,000 per month for 6 years), or received monthly in an amount of $2,000 until the mutual member has an accident.

At this time, member D chooses to receive the non-accident profit monthly in an amount of $2,000, and member E chooses to receive the non-accident profit in a lump sum in an amount of $150,000. Then, the system remits the non-accident profits of $2,000 and $150,000 to the nominated accounts of members D and E according to their choices respectively.

Up to the clearing day of that month, one member died and two members have met the profit term in total in that month, and the microprocessor 111 of the process apparatus 11 calculates the current payment amount to be $370,000+$2,000+$150,000=$522,000. Assuming that the mutual unit amount chosen by all non-accident members who should pay the premium is 4,000 mutual units, then the microprocessor 111 of the process apparatus 11 calculates the current insurance unit value to be $522,000/4,000=$130.5, i.e., $130.5 per mutual unit. Then, if Xiao Hua's father only chooses 2 mutual units in the current period, he should pay a current mutual premium of $130.5×2=$261.

Then, in June of the next year, member E unfortunately has an accident. Because member E has already met the profit term and the accumulated premium payment he has paid has amounted to the standard payment amount of $500,000, he can receive a benefit of $500,000 in a lump sum (plus the non-accident profit of $150,000 previously received in a lump sum totaling $650,000 received until the accident). In the same month, members F and G have also had an accident respectively. Member F has joined the mutual insurance assembly for less than two years (i.e., having an accident in the exclusive period), so he can only receive a compensation of $15,000, i.e., the total premium amount paid by member F since he joined the mutual insurance assembly. On the other hand, member G has joined the mutual insurance assembly for longer than the exclusive period, so the microprocessor 111 calculates the benefit by weighing the mutual units chosen by the member G in the last two years respectively. In the last two years, instead of determining the insurance units by member G himself, the process apparatus 11 collected premiums from member G at an agreed amount of 6 mutual units in each insurance period, so member G can now receive a benefit of $360,000.

Hence, in the current insurance period (June), three mutual members (i.e., E, F and G) in total have had an accident respectively and received benefits of $500,000, $15,000 and $360,000 respectively. Furthermore, because member D has not had an accident, the system continues to pay the non-accident profit of $2,000 to the member D to result in a current payment amount of $500,000+$15,000+$360,000+$2,000=$877,000 in this insurance period. Assuming that the mutual unit amount chosen by all non-accident members who should pay the premium in the current insurance period is 5,000 mutual units, then the microprocessor 111 of the process apparatus 11 calculates the current insurance unit value to be $877,000/5,000=$175.4, i.e., $175.4 per unit. Then, if Xiao Hua's father is not as healthy in that year and chooses 8 mutual units, he should pay a current mutual premium of $175.4×8=$1403.2, which rounds to $1404.

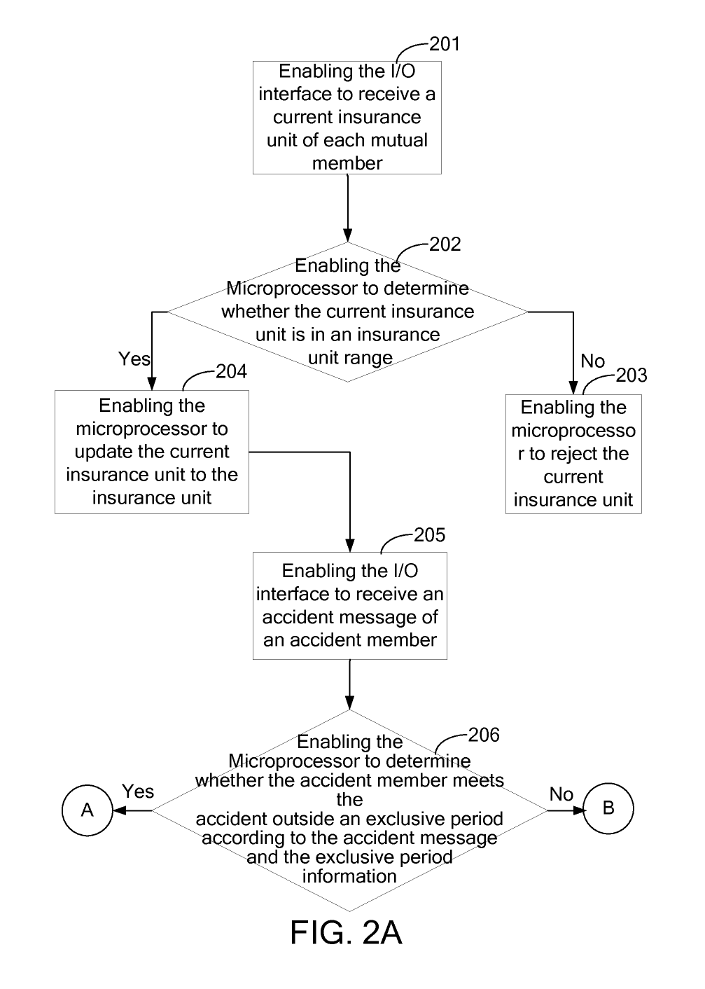

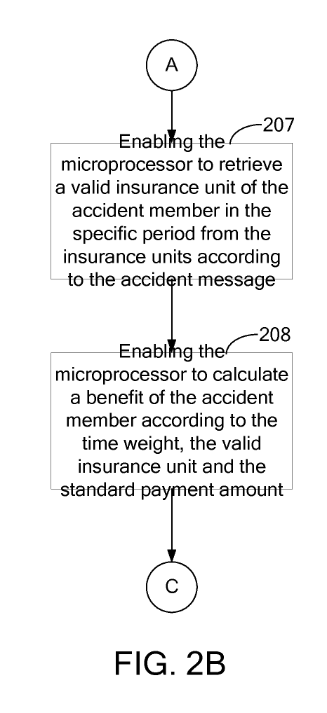

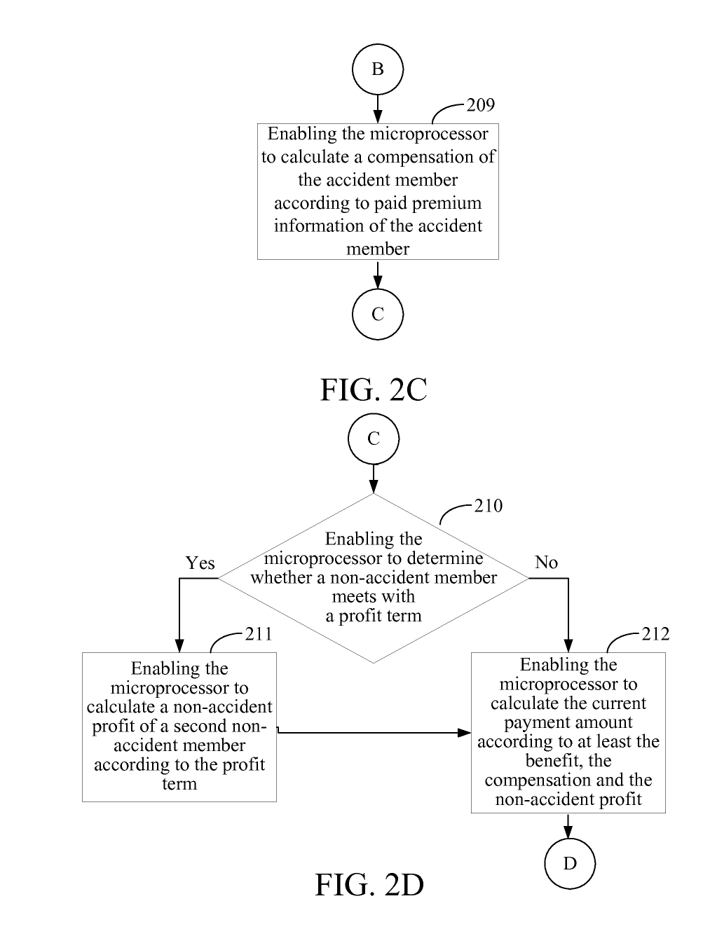

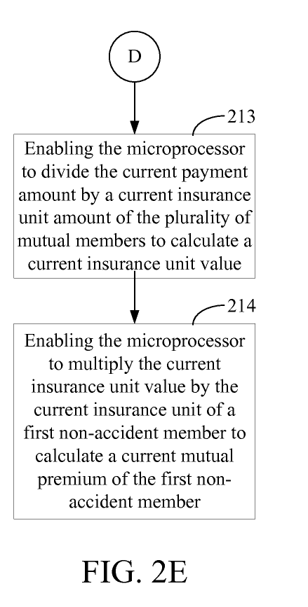

A second example embodiment of the present invention is shown in FIGS. 2A to 2D, which depict a flowchart of a mutual insurance method performed by the process apparatus described in the first example embodiment. The process apparatus comprises a microprocessor, a storage and an input/output (I/O) interface. The microprocessor is electrically connected to the storage and the I/O interface respectively. The storage is configured to store mutual information of a mutual insurance assembly which has a plurality of mutual members. The mutual information comprises a time weight of a specific period, an insurance unit of each of the plurality of mutual members, a standard payment amount, an insurance unit range, exclusive period information, a profit term and paid premium information of each of the plurality of mutual members. The functions of the information elements comprised in the mutual information will be described hereinafter.

The mutual insurance assembly comprises a plurality of insurance periods, and each mutual member who joins the mutual insurance assembly needs to choose a current insurance unit according to his or her own condition in each insurance period. In other words, the insurance unit of each mutual member may vary in different insurance periods. First, in reference to FIG. 2A, in the second embodiment, step 201 is firstly executed to enable the I/O interface to receive a current insurance unit of each of the plurality of mutual members in each of the plurality of insurance periods. The insurance unit of each of the plurality of mutual members described above is just configured to record the insurance units (e.g., a last insurance unit and a current insurance unit) of the mutual member in each insurance period.

The insurance unit range is configured to prevent a mutual member who anticipates an immediate accident to unfairly choose a large mutual unit in the next insurance period. Specifically, after the current insurance unit is received, step 202 is executed to enable the microprocessor to determine whether the current insurance unit is in the insurance unit range according to the last insurance unit of each of the plurality of mutual members in the last insurance period.

If it is determined in step 202 that the current insurance unit is not in the insurance unit range, step 203 is executed to enable the microprocessor to reject the current insurance unit of the mutual member in this insurance period. Otherwise, if it is determined in step 202 that the current insurance unit amount is in the insurance unit range, step 204 is executed to enable the microprocessor to accept the current insurance unit of the mutual member in this insurance period, and to update and record the current insurance unit to the insurance unit of the mutual member.

For example, assume that the insurance unit range specifies that an insurance unit in each insurance period should not exceed that of the last insurance period by a fixed value (e.g., 3 units) or a proportion (e.g., thirty percent), and that the last insurance unit is 5 units. Then, a current insurance unit should be not more than 8 units according to the fixed value or not more than 6.5 units according to the proportion. Thus, the insurance unit range can be defined clearly so that the premiums of each mutual member increase in a gradual way to prevent abnormal insurance increments made by a speculator. Depending on practical applications, the aforesaid insurance unit range may be a different range in other embodiments, and this is not intended to limit the scope of the present invention.

In the case a mutual member has an accident, the mutual insurance method will execute steps related to the settlement of claims/compensation. For ease of the following description, the mutual member who has accident will be, in short, referred to as an accident member hereinafter. In other words, the aforesaid plurality of mutual members comprises the accident member.

Step 205 is executed to enable the I/O interface to receive the accident message of the accident member, and then step 206 is executed to enable the microprocessor to determine whether the accident member meets the accident outside an exclusive period according to the accident message and the exclusive period information to perform subsequent processing correspondingly. Specifically, the accident message may comprise information of the accident member such as an ID number, an age, the time of joining the mutual insurance assembly and the time of the accident. The exclusive period is a mechanism configured to prevent moral risks: if the mutual member could receive a total insurance benefit after joining the mutual insurance assembly for only several months, it would be unfair for other mutual members.

In this embodiment, the exclusive period is two years. Next, step 206 is executed to determine whether the difference between the time of the accident member joining the mutual insurance assembly and the time of the accident is more than two years. If the answer is “yes”, then it is determined that the accident member had the accident outside the exclusive period; otherwise, if the answer is “no”, then it is determined that the accident member had the accident in the exclusive period.

If it is determined in step 206 that the accident member had the accident outside the exclusive period, then, in reference to FIG. 2B, step 207 is executed to enable the microprocessor to retrieve the valid insurance unit of the accident member in the specific period from the insurance unit stored in the storage according to the accident message. Then, step 208 is executed to enable the microprocessor to calculate the benefit of the accident member according to the time weight, the valid insurance unit and the standard payment amount, and to remove the accident member from the mutual insurance assembly.

Specifically, if each insurance period is a quarter and the specific period is the last two years before the accident, then the insurance units of the accident member in each of the last eight insurance periods before the accident are recorded in the valid insurance unit. Step 208 is to take the weighted average of the chosen mutual units (i.e., the insurance units in the last eight insurance periods) according to the time weights (i.e., the time weights of the last two years before the accident), and to make an operation on the standard payment amount according to the resulting weighted average to calculate the benefit for the current accident of the accident member.

The purpose of making the aforesaid operation according to the time weights, the valid insurance unit and the standard payment amount is that the more mutual units the accident member has chosen (i.e., the more mutual premiums the accident member has paid) in the last several insurance periods, the more benefit the mutual member can receive after an accident. Thus, when choosing a mutual unit amount, the mutual member will assess his or her own health conditions so that the mutual premiums can reflect the health conditions of the mutual member faithfully. By collecting different premiums according to the true risk status of the policyholders, the inequalities that result from the prior art can be prevented.

More specifically, in this embodiment, the benefit of the accident member is determined by the following formula:

$$Pi = Ps \times {\sum }_{j}^{ } {G}_{j} {W}_{j}$$

where, Pi represents the benefit of the accident member, Ps represents the standard payment amount, Gⱼ represents the mutual unit paid in the j^{th} insurance period before an accident, and Wⱼ represents a time weight of the j^{th} insurance period before an accident. It should be noted that in other embodiments, the benefit of the accident member may also be determined by other formulas, and this is not intended to limit the scope of the present invention.

If it is determined in step 206 that the accident member meets the accident in an exclusive period, then, in reference to FIG. 2C, step 209 is executed to enable the microprocessor to calculate the compensation of the accident member according to the paid premium information of the accident member. Specifically, in this embodiment, the amount of compensation is equal to an accumulated total of premiums paid by the accident member after joining the mutual insurance assembly plus interests. It should be noted that in other embodiments, the compensation may also be calculated in other ways, and this is not intended to limit the scope of the present invention.

The above description describes the method in which the mutual insurance method calculates the benefit or the compensation for an accident member when the mutual member has an accident. However, for the mutual insurance assembly, accident members only account for a very small percentage of all mutual members, so the following description will focus on what roles the mutual members that haven't had an accident (referred to as “non-accident members” hereinafter) will play in the mutual insurance assembly and what information the mutual insurance method will generate for non-accident members in each insurance period.

After calculating the benefit and/or the compensation of all accident members, in reference to FIG. 2D, step 210 is executed to enable the microprocessor to determine whether each non-accident member meets the profit term to perform subsequent steps correspondingly. In this embodiment, the profit term may be that the premiums paid by the non-accident member reaches a predetermined value and that the time of the non-accident member joining the mutual insurance assembly reaches a predetermined time. For example, the profit term may be set so that the time of the non-accident member joining the mutual insurance assembly has reached a preset time (e.g., 240 insurance periods in 20 years (one insurance period per month)) and/or that the accumulated premium paid by the non-accident member in previous insurance periods has reached a predetermined value (e.g., the standard payment amount).

In other words, step 210 is to determine whether the premiums paid by each non-accident member have reached the predetermined value or that the time of each non-accident member joining the mutual insurance assembly has reached the predetermined time. It should be noted that in other embodiments, the profit term may be adjusted depending on practical applications, and this is not intended to limit the scope of the present invention. For ease of the following descriptions, non-accident members that do not meet the profit term will be referred to as first non-accident members, while non-accident members that meet the profit term will be referred to as second non-accident members.

If it is determined in step 210 that the non-accident member is a second non-accident member, step 211 is executed to enable the microprocessor to calculate a non-accident profit of the second non-accident member according to the profit term. Specifically, the non-accident profit may be viewed as a survivorship mutual fund or a survivorship annuity, which aims to reward those who have an accident later or to support the daily life of those who live longer. The non-accident profit may be paid in a lump sum, in installments, or on a regular basis at a fixed amount, for example, in the form of an annuity or monthly petty cash.

Generally speaking, the non-accident profit is related to the number of accident members of previous insurance periods in the mutual insurance assembly; i.e., the more accident members, the more non-accident profit premiums are contributed by the accident members to the non-accident members. This is intended to overcome the shortcoming of the prior art that those who have an accident later in the mutual insurance assembly have to pay more premiums, so that insurance benefits can be allocated in a fairer way to accident members who have an accident in different periods. Therefore, those who have accident earlier cannot receive the non-accident profit, but the mutual members who have not had accident yet and continuously pay premiums can obtain the non-accident profit as a reward for their longevity and for their continuous payment of mutual premiums.

If it is determined in step 210 that the non-accident member is a first non-accident member, step 212 is executed to enable the microprocessor to calculate the current payment amount according to at least the non-accident profits of all the first non-accident members and the benefits and/or compensations of the accident members in each insurance period. Then, in reference to FIG. 2E, step 213 is executed to enable the microprocessor to divide the current payment amount by the current insurance unit amount of the plurality of mutual members to calculate the current insurance unit value in each insurance period. Finally, step 214 is executed to enable the microprocessor to multiply the current insurance unit value by the current insurance unit of the first non-accident member to calculate the current mutual premium that the first non-accident member should pay.

Specifically, to ensure sustainability of the mutual insurance assembly, the mutual insurance method averagely apportions the current payment of the mutual insurance assembly including the non-accident profits of all the first non-accident members and the benefits and/or compensations of the accident members to the current insurance units in each insurance period so that each insurance unit bears the same payment amount. Accordingly, mutual members with more current insurance units will bear a higher premium, while mutual members with fewer smaller current insurance units will bear a lower premium. This mechanism is intended to allow a mutual member to determine his mutual units according to his current financial ability. For example, if the mutual member does not have enough funds in the current period, he may choose fewer mutual units to maintain his mutual membership and continue to enjoy the insurance by paying a lower premium. This flexibility in payment also helps to meet with demands of most applicants under the principle of equity to promote their participation in the mutual insurance.

While choosing fewer mutual units and paying a lower mutual premium, the mutual member may be aware that in subsequent insurance periods, he shall be more cautious, pay more attention to his own health and diet, or pay more attention to the maintenance of workshop and safety facilities to decrease the probability of having an accident. This leads to another positive effect of the improved mutual insurance method of the present invention; that is, it not only provides the members insurance benefits when having an accident, but also substantially reduces the probability of having an accident.

The current insurance unit value and the current mutual premium can be determined by the following two formulas:

V=Pₐₗₗ/Gₙₐₗₗ

I=Gₙ*V

where, V represents the current insurance unit value, Pₐₗₗ all represents the current payment amount, Gₙₐₗₗ represents the current insurance unit amount, I represents the current mutual premium, and Gₙ represents the current insurance unit of a first non-accident member.

In addition to the aforesaid steps, the second embodiment can also execute all the operations and functions set forth in the first embodiment. The method in which the second embodiment executes these operations and functions will be readily appreciated by those of ordinary skill in the art based on the explanation of the first embodiment, and thus will not be further described herein.

According to the above descriptions, the present invention allows policyholders to adjust their own premiums flexibly according to their own conditions so that the premium amounts can faithfully reflect their own values-at-risk. Thus, risks can be positively controlled to significantly reduce speculative insurance events. Meanwhile, the probability of inappropriate risk assessment can be decreased to reduce the cost of risk assessment. Moreover, allowing users to determine premiums is compatible with the current operation mode of the Internet, which can not only significantly improve transparency and operation efficiency of the mutual insurance assembly to reduce operational and administrational costs, but also significantly improve the mutual equity and impartiality of the premium payment in the mutual insurance assembly, thereby effectively overcoming shortcomings of the prior art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A mutual insurance method performed by a process apparatus, the process apparatus comprising a microprocessor, a storage and an input/output (I/O) interface, the microprocessor being electrically connected to the storage and the I/O interface respectively, the storage being configured to store mutual information of a mutual insurance assembly, the mutual insurance assembly having a plurality of mutual members, the plurality of mutual members comprising an accident member, the mutual information comprising a time weight of a specific period, an insurance unit of each of the plurality of members and a standard payment amount, the mutual insurance method comprising the steps of:
enabling the I/O interface to receive an accident message of the accident member;
enabling the microprocessor to retrieve a valid insurance unit of the accident member in the specific period, according to the accident message, from the insurance units of the storage; and
enabling the microprocessor to calculate a benefit of the accident member according to the time weight, the valid insurance unit and the standard payment amount.

2. The mutual insurance method as claimed as claim 1, wherein the mutual insurance assembly comprises a plurality of insurance periods, the mutual information further comprises an insurance unit range, the mutual insurance method further comprises the steps of:
enabling the I/O interface to receive a current insurance unit of each mutual member in each insurance period;
enabling the microprocessor to determine that the current insurance unit is in the insurance unit range according to a last insurance unit of each mutual member in a last insurance period to generate a determination result; and
enabling the microprocessor to update the current insurance unit of each mutual member to the insurance unit of each mutual member according to the determination result.

3. The mutual insurance method as claimed as claim 1, wherein the mutual information further comprises exclusive period information, the mutual insurance method further comprises the step of:
enabling the microprocessor to determine that the accident member meets an accident outside an exclusive period according to the accident message and the exclusive period information.

4. The mutual insurance method as claimed as claim 3, wherein the mutual information further comprises paid premium information of each mutual member, the mutual insurance method further comprises the steps of:
enabling the microprocessor to determine that the accident member meets an accident in an exclusive period according to the accident message and the exclusive period information; and
enabling the microprocessor to calculate a compensation of the accident member according to the paid premium information of the accident member.

5. The mutual insurance method as claimed as claim 2, wherein the plurality of mutual members comprise a first non-accident member, the mutual insurance method further comprises the steps of:
(A) enabling the microprocessor to calculate a current payment amount according to at least the benefit in each insurance period;
(B) enabling the microprocessor to divide the current payment amount by a current insurance unit amount of the mutual members to calculate a current insurance unit value; and
(C) enabling the microprocessor to multiply the current insurance unit value by the current insurance unit of the first non-accident member to calculate a current mutual premium of the first non-accident member.

6. The mutual insurance method as claimed as claim 5, wherein the plurality of mutual members comprise a second non-accident member, the mutual information comprises a profit term, the mutual insurance method further comprises the steps of:
(D) enabling the microprocessor to determine that the second non-accident member fills the profit term; and
(E) enabling the microprocessor to calculate an non-accident profit of the second non-accident member according to the profit term.

7. The mutual insurance method as claimed as claim 6, wherein the profit term may be one of that the premium paid by the second non-accident member is equal to a predetermined value and that the time of the second non-accident member joining in the mutual insurance assembly is equal to a predetermined time, the step (D) may further be a step of enabling the microprocessor to determine that the second non-accident member fills one of that the premium paid by the second non-accident member is equal to a predetermined value and that the time of the second non-accident member joining in the mutual insurance assembly is equal to a predetermined time.

8. The mutual insurance method as claimed as claim 6, wherein the step (A) may further be a step of enabling the microprocessor to calculate the current payment amount according to the benefit and the non-accident profit in each insurance period at least.

9. A process apparatus for performing a mutual insurance method, comprising:
a storage, being configured to store mutual information of a mutual insurance assembly, the mutual insurance assembly having a plurality of mutual members, the plurality of mutual members comprising an accident member, the mutual information comprising a time weight of a specific period, an insurance unit of each of the plurality of members and a standard payment amount;
an I/O interface, being configured to receive an accident message of the accident member; and
a microprocessor, being electrically connected to the storage and the I/O interface to retrieve a valid insurance unit of the accident member in the specific period, according to the accident message, from the insurance units of the storage, and being configured to calculate a benefit of the accident member according to the time weight, the valid insurance unit and the standard payment amount.

10. The process apparatus as claimed as claim 9, wherein the mutual insurance assembly comprises a plurality of insurance periods, the mutual information further comprises an insurance unit range, the I/O interface is further configured to receive a current insurance unit of each mutual member in each insurance period, the microprocessor is further configured to:
determine that the current insurance unit is in the insurance unit range according to a last insurance unit of each mutual member in a last insurance period to generate a determination result; and
update the current insurance unit of each mutual member to the insurance unit of each mutual member according to the determination result.

11. The process apparatus as claimed as claim 9, wherein the mutual information further comprises exclusive period information, the microprocessor is further configured to determine that the accident member meets an accident outside an exclusive period according to the accident message and the exclusive period information.

12. The process apparatus as claimed as claim 11, wherein the mutual information further comprises paid premium information of each mutual member, the microprocessor is further configured to:
determine that the accident member meets an accident in an exclusive period according to the accident message and the exclusive period information; and
calculate a compensation of the accident member according to the paid premium information of the accident member.

13. The process apparatus as claimed as claim 10, wherein the plurality of mutual members comprise a first non-accident member, the microprocessor is further configured to:
calculate a current payment amount according to the benefit in each insurance period at least;
divide the current payment amount by a current insurance unit amount of the mutual members to calculate a current insurance unit value; and
multiply the current insurance unit value by the current insurance unit of the first non-accident member to calculate a current mutual premium of the first non-accident member.

14. The process apparatus as claimed as claim 13, wherein the plurality of mutual members comprise a second non-accident member, the mutual information comprises a profit term, the microprocessor is further configured to:
determine that the second non-accident member fills the profit term; and
calculate a non-accident profit of the second non-accident member according to the profit term.

15. The process apparatus as claimed as claim 14, wherein the profit term may be one of that the premium paid by the second non-accident member is equal to a predetermined value and that the time of the second non-accident member joining in the mutual insurance assembly is equal to a predetermined time, the microprocessor is further configured to determine that the second non-accident member fills one of that the premium paid by the second non-accident member is equal to a predetermined value and that the time of the second non-accident member joining in the mutual insurance assembly is equal to a predetermined time.

16. The process apparatus as claimed as claim 14, wherein the microprocessor is further configured to calculate the current payment amount according to the benefit and the non-accident profit in each insurance period at least.
